(19) United States
(12) Patent Application Publication
(10) Pub. No.: US 2007/0038517 A1
(43) Pub. Date: Feb. 15, 2007

(54) Point-of-sale terminal

(76) Inventor: Zhe Lin, Guangdong (CN)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/549,087

(22) PCT Filed: Mar. 17, 2004
(86) PCT No.: PCT/CN04/00211

§ 371 Date: Aug. 24, 2006

(30) Foreign Application Priority Data
Mar. 22, 2003 (CN) 03224527.0

(51) Int. Cl. G06Q 20/00

(52) U.S. Cl. 705/17

(57) ABSTRACT

A POS terminal includes a display, basic computer components and a housing in which basic computer components are mounted. The display is a flat panel display. A convex-block for positioning the display is provided on the back of the display. The housing comprises at least two carrying surfaces, at least one seating surface which bears the weight of the POS terminal, and two side surfaces. A recess is provided on each carrying surface for engaging the convex block on the display. Moreover, an angle between one of the carrying surfaces and one of the seating surfaces is different from another one of the carrying surfaces and the one of the seating surfaces.

### FIELD OF THE INVENTION

The present application relates to a data processing device, and more particularly, to a data processing device having input and output functions. Specifically, the present application relates to a Point-Of-Sale terminal.

### BACKGROUND OF THE INVENTION

POS terminals, as a kind of data processing device having input and output functions, have been widely used in retail trade in large shops, supermarkets, and the like. A POS terminal typically comprises a display, basic computer components, a housing for mounting the basic computer components, a keyboard, a printer, a cashbox, and the like.

An existing POS terminal generally employs a traditional combined type design, in which the display, the printer, and the keyboard are all placed on the housing, and the housing with all the assembly thereon is then placed on the cashbox. This kind of design has a stacked structure and a complex appearance as well as a relatively large size, that requires a large space to be used.

After LCD has been developed, it is used to replace the monochrome display. However, this replacement can only make the display itself thinner, but the size of the whole POS terminal is still large.

With time goes on, the POS terminal has been used not only for large shops and supermarkets, but also more and more for small businesses. In the near future, small booths and stands will be the largest group of customers of the electronic POS terminals.

Therefore, there is an urgent need for an electronic POS terminal, which occupies small space, can be placed freely anywhere, and can be easily understood and operated.

### SUMMARY OF THE INVENTION

An object of this application is to provide a POS terminal, which occupies a small space, has good stability and an appealing appearance. The tilting angle of the display screen thereof can be adjusted according to the user's need when he/she operates and reads the machine.

To achieve the above object, the POS terminal of the present application mainly comprises a display, basic computer components and a housing, in which the basic computer components are mounted. The display is a flat panel display. A positioning convex-block for positioning the display is provided on the back of the display. The housing is a geometrical body consisting of at least two carrying surfaces having a recess provided therein for engaging the positioning convex-block, at least one seating surface for contacting a supporting surface, and two side surfaces. An angle between one of the carrying surfaces and one of the seating surfaces is different from an angle between another one of the carrying surfaces and the one of the seating surfaces. The intersecting lines between a carrying surface and another carrying surface or between a carrying surface and a seating surface are parallel with each other.

The housing has three carrying surfaces and one seating surfaces. The angle between each of the three carrying surfaces and the one seating surface is about 25-35°, 55-65° and 70-80°, respectively, so that the housing has better stability when being subjected to external force, and can be operated easily and comfortably.

Preferably, the angle between each of the three carrying surfaces and the one seating surface is about 30°,60° and 75°, respectively, and the two side surfaces are parallel with each other.

In order to reduce inconvenience of operating the keyboard, the display is a touch type liquid crystal display.

The positioning convex block of the display is provided with a guiding hole for leading out the cables of the display, and the recess formed on the carrying surface is provided with an inserting hole for inserting the cables of the display, so that the combination of the display and the housing seems more integrated.

A protruding interface for a peripheral device is provided at the lower portion of each side surface of the housing, so that the printer and the cashbox are not loosely placed together and the whole POS terminal has better stability.

A thermo vent is provided at the upper portion of each side surface of the housing.

A socket for inserting an ID card is provided on one side of the display and a slot for reading a creditor debit card is provided on the other side of the display. Such placement is to make the whole POS terminal compact and to reduce the number of components.

The advantages of the POS terminal of the present application comprise:

1. Since the housing for mounting the basic computer components serves as the supporting base of the display, the display is conveniently positioned and securely fastened by the engagement between the positioning convex block on the back of the display and the recess in the carrying surface of the housing. The housing has at least two surfaces which can be used as the carrying surface of the display. An operator can assemble the POS terminal in different ways as desired to obtain different reading and operating angles.

2. The display is a touch type LCD, which saves space for a keyboard, and the interfaces for peripheral devices are provided on the sides of the housing so that the printer and the cashbox are not loosely assembled, therefore, the occupied volume of the whole POS terminal can be greatly reduced. Also, operation positions can be selected more freely so that the POS terminal can be adapted to be used by various people in various conditions.

3. The angle between each carrying surface and the seating surface of the housing guarantees stability of the whole POS terminal used in various states. The clever arrangement of the interfaces for peripheral device on both sides of the housing increases not only the bottom width of the housing, but also the weight of the housing. Such increase improves operability and stability of the touch screen.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a structural and assembly schematic view of the display and the housing of the POS terminal according to the present application;

FIG. 2 is a schematic structural view showing the back of the display of the POS terminal according to the present application;

FIG. 3 is a schematic structural view showing the side of the display of the POS terminal according to the present application;

FIG. 4 is a reference drawing showing the POS terminal according to the present application in a first use state;

FIG. 5 is a reference drawing showing the POS terminal according to the present application in a second use state; and

FIG. 6 is a reference drawing showing the POS terminal according to the present application in a third use state.

### DETAILED DESCRIPTION OF THE PREFERRED EMBODIMENTS

Reference will now be made in detail to the preferred embodiments of the present application, examples of which are illustrated in the accompanying drawings, wherein like reference numerals refer to like elements throughout.

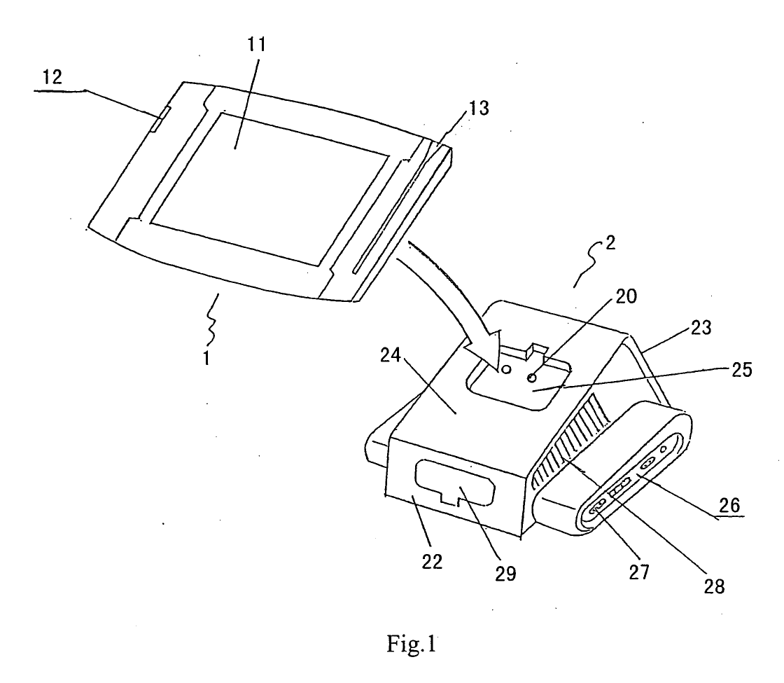

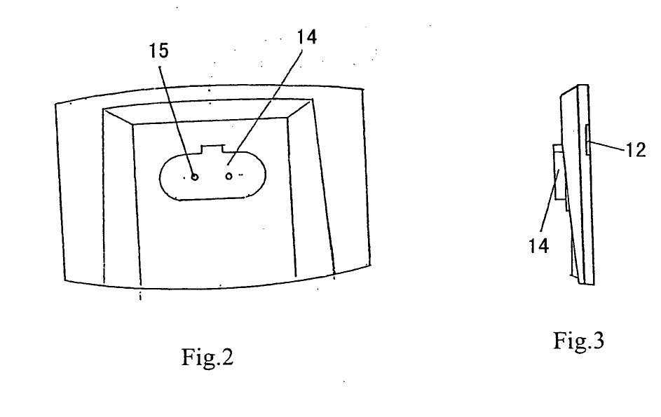

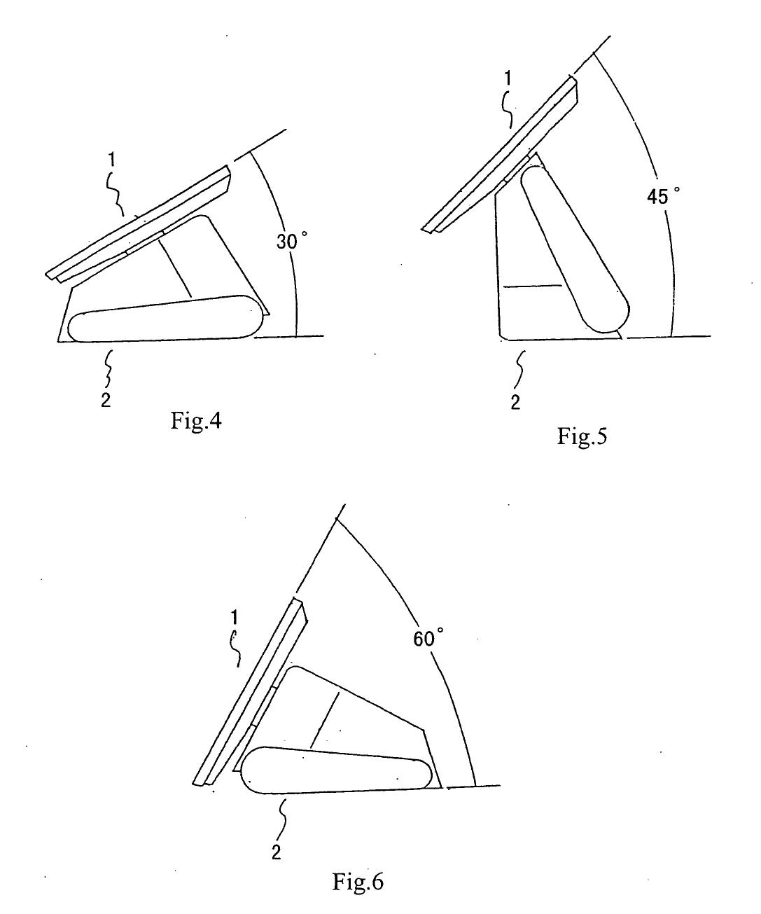

As shown in FIGS. 1, 2 and 3, the POS terminal of the present application comprises a liquid crystal display (LCD) 1, basic computer components such as a power source, a main board, a CPU and the like, a housing 2 for mounting the basic computer components. The LCD is a touch type display, and there is a socket at the upper left corner of the outer frame of the display screen 11 for inserting an ID card, and a slot for reading a creditor debit card is provided at a right side of the outer frame. A positioning convex block 14 is provided at a center of the back of the display, and holes 15 through which the cables of the display pass is formed near the center of the convex block 14. The housing 2 has a hexahedral shape, the left side surface and the right side surface thereof are parallel with each other, each of the front surface 22, the back surface 23 and the top surface 24 thereof can serve as a carrying surface for bearing the display, and the bottom surface thereof serves as a seating surface for contacting a supporting surface. Each of the three carrying surfaces is provided with a recess mated with the convex block of the display for engaging with the convex block, and the recess is provided with inserting holes 20 for passing through the cables of the display and a cover 29 which is opened when being used and closed when being out of use. Each of the carrying surfaces has a predetermined slope, and an angle between one of the carrying surfaces and the bottom surface is different from another one of the carrying surfaces and the bottom surface, so that the display screen has different operating angles. According to condition of the force applied to the geometrical body and requirement of human engineering, the operating angle of the display screen is preferably about 30°,45° or 60°. Therefore, the angle between each of the three carrying surfaces and the bottom surface is preferably about 25-35°, 55-65° and 70-80° respectively, and most preferably, the angle between each of the three carrying surfaces and the bottom surface is about 30°, 60° and 75° respectively. Specifically, the angle between the top surface 24 and the bottom surface is designed as 30° as shown in FIG. 4, the angle between the back surface 23 and the bottom surface is designed as 60° as shown in FIG. 6, and the angle between the front surface 22 and the bottom surface is designed as 75°, i.e., the angle between the front surface 22 and the back surface 23 is 45°, as shown in FIG. 5, in which case, the front surface 22 serves as the carrying surface for bearing the display, and the back surface 23 serves as the seating surface for contacting the supporting surface. A strip-shaped projecting block 26 extends outwardly at the lower portion of each of the left side surface and the right side surface of the housing, and an inwardly recessed interface 27 is provided in the outer side of each of the projecting block 26 for connecting the printer, the cashbox, etc., so that the printer and the cashbox can be placed separately. A strip-shaped thermo vent 28 is provided at the upper portion of each of the left side surface and the right side surface of the housing, which facilitates the heat dissipation of the components inside the housing during operation.

In use, a suitable reading and operating angle is selected firstly, and then the cables of the display is passed through the positioning convex block of the display and inserted into the inserting hole in the recess of the carrying surface of the housing, and finally the positioning convex block is engaged in the recess of the carrying surface.

Although a preferred embodiment of the present application has been shown and described above, it should not be construed as limiting the scope of the present application. Any modification or equivalent embodiment without departing from the principles and spirit of the present application is within the scope of the present application.

1-8. (canceled)

9. A Point-Of-Sale (POS) terminal, comprising:
a display, the display being a flat panel display;
a housing; the housing being a geometrical body consisting of at least two carrying surfaces, at lease one seating surface for contacting a supporting surface and two side surfaces;
basic computer components mounted in the housing;
a positioning means located on the back of the display; and
a recess located in each of the at least two carrying surfaces adapted to engage the positioning means,
wherein an angle between one of the at least two carrying surfaces and one of the at least one seating surfaces is different from an angle between another one of the at least two carrying surfaces and the one of the at least one seating surfaces.

10. The POS terminal according to claim 9, wherein the positioning means is a positioning convex block.

11. The POS terminal according to claim 10, wherein the housing has a hexahedral shape, a front surface, a back surface or a top surface of the housing can serve as the carrying surface, and a bottom surface or the back surface of the housing can serve as the seating surface, wherein the angle between each of the top surface, the back surface and the front surface and the bottom surface is respectively about 25-35°, 55-65° and 70-80°.

12. The POS terminal according to claim 11, wherein the angle between each of the top surface, the back surface and the front surface and the bottom surface is respectively about 30°, 60° and 75°, and two side surfaces of the housing are parallel with each other.

13. The POS terminal according to claim 10, wherein the positioning convex block of the display is provided with a guiding hole for leading out the cables of the display, and the recess formed in the carrying surface is provided with a inserting hole for inserting the cables of the display.

14. The POS terminal according to claim 9, wherein the display is a touch type liquid crystal display.

15. The POS terminal according to claim 9, wherein a protruding interface for a peripheral device is provided at the lower portion of each side surface of the housing.

16. The POS terminal according to claim 9, wherein a thermo vent is provided at the upper portion of each side surface of the housing.

17. The POS terminal according to claim 9, wherein a socket for inserting an ID card is provided on one side of the display, and a slot for reading a creditor debit card is provided on the other side of the display.
